(19) United States
(12) Patent Application Publication
(10) Pub. No.: US 2016/0050072 A1
(43) Pub. Date: Feb. 18, 2016

(54) DIGITAL APPARATUS FOR SEPARATELY SAVING AN ACCOUNT NUMBER AND PASSWORD FOR ANTI-HACKING PURPOSES

(71) Applicant: Chi-Pei WANG, Hsinchu City (TW)

(72) Inventor: Chi-Pei WANG, Hsinchu City (TW)

(21) Appl. No.: 14/821,052

(22) Filed: Aug. 7, 2015

(30) Foreign Application Priority Data
Aug. 15, 2014 (TW) 103128032

(51) Int. Cl. H04L 9/32; H04L 29/06

(52) U.S. Cl. CPC H04L 9/3234; H04L 63/083; H04L 63/0853; H04L 9/3226

(57) ABSTRACT

A digital apparatus being capable of separately saving account number and corresponding password for anti-hack includes a smart computing device for running a separating-type secret account management software to divide an encrypted account number and corresponding password into two parts that are respectively saved in two different devices. The separating-type secret account management software respectively collects the separated account number and corresponding password and recovers the divided account number and corresponding password to a complete and encrypted account number and corresponding password when the operator want to use the account number and corresponding password.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to a digital apparatus, and more particularly to a digital apparatus being capable of separately saving an account number and corresponding password for anti-hacking purposes.

2. Description of Related Art Including Information Disclosed Under 37 CFR 1.97 and 37 CFR 1.98

Typically, the computer operator must completely save his/her account number and corresponding password somewhere, such as a hard disk of a computer, a smart phone or a USB flash drive, when he/she does not like typing in the account number and corresponding password and logs in by copy-and-paste. Accordingly, the account number and the corresponding password are saved in a singular system such that the hacker can easily break in and steal the account number and corresponding password of the operator via computer and internet. This situation causes problems and worries about the safety of a user's account number and the corresponding password. Furthermore, the property safety of a large number of computer users is seriously imperiled.

In view of this, some computer peripherals manufacturers provide some anti-skimming keyboards, anti-loggers and anti-skimming cables for consumers, but are having some problems and inconvenience because that needs to be used with a function of internet decryption. However, the decryption point of the conventional anti-skimming computer system must be constructed in an application server, such as a server of a bank. As a result, the application server needs to change the original web page and server programs for being coupled with the setting processes of encryption and decryption. As such, the set-up cost and administrative cost are generated. Consequently, internet bankers usually have no intent to build an anti-skimming computer network system for customers without external pressures, such as laws and regulations. As a result, the transaction on the internet bank is not very safe such that the consumers are not eager to use the internet bank and the effect of the internet bank is lowered. Furthermore, some functions of the internet bank are deleted to reduce the trading risk and the customers cannot use a convenient internet bank, such as non-consensual transfer.

The present invention has arisen to mitigate and/or obviate the disadvantages of the conventional anti-skimming computer network system.

### BRIEF SUMMARY OF THE INVENTION

The main objective of the present invention is to provide an improved digital apparatus that is capable of separately saving an account number and corresponding password for anti-hacking purposes.

To achieve the objective, the digital apparatus in accordance with the present invention comprises a smart computing device that can be connected to at least one cloud system via the internet. A separating-type secret account management software is installed run and in the smart computing device for encrypting an account number and corresponding password. The separating-type secret account management software respectively divides the account number and corresponding password into two parts, wherein one part of the account number and corresponding password is saved in the smart computing device and the other part of the account number and corresponding password is saved in the at least one cloud system. The separating-type secret account management software collects the separated account number and corresponding password from the smart computing device and the at least one cloud system, and recovers the divided account number and corresponding password to a complete and encrypted account number and corresponding password when the operator want to use the account number and corresponding password. A decryption server is connected to the smart computing device for transceiving data and decrypting the complete and encrypted account number and corresponding password. An application server is connected to the decryption server for receiving the decrypted account number and corresponding password from the decryption server.

The separating-type secret account management software respectively collects the separated account number and corresponding password from the smart computing device and the at least one cloud system, and recovers the divided account number and corresponding password to a complete and encrypted account number and corresponding password when the operator want to use the account number and corresponding password. The complete and encrypted account number and corresponding password is transmitted to the decryption server such that the digital apparatus in accordance with the present invention can prevent the account number and corresponding password from being stolen during transmitting through the internet and prevent the account number and corresponding password from being broken and stolen when being saved in a single system.

Further benefits and advantages of the present invention will become apparent after a careful reading of the detailed description with appropriate reference to the accompanying drawings.

### BRIEF DESCRIPTION OF THE SEVERAL VIEWS OF THE DRAWINGS

FIG. 1 is a schematic view of a digital apparatus being capable of separately saving an account number and corresponding password for anti-hacking purposes in accordance with the present invention.

FIG. 2 is a processing flow chart of the digital apparatus being capable of separately saving an account number and corresponding password for anti-hacking purposes.

FIG. 3 is a schematic view of a second embodiment of the digital apparatus being capable of separately saving an account number and corresponding password for anti-hacking purposes in accordance with the present invention.

FIG. 4 is a processing flow chart of the digital apparatus being capable of separately saving an account number and corresponding password for anti-hacking purposes as shown in FIG. 3.

### DETAILED DESCRIPTION OF THE INVENTION

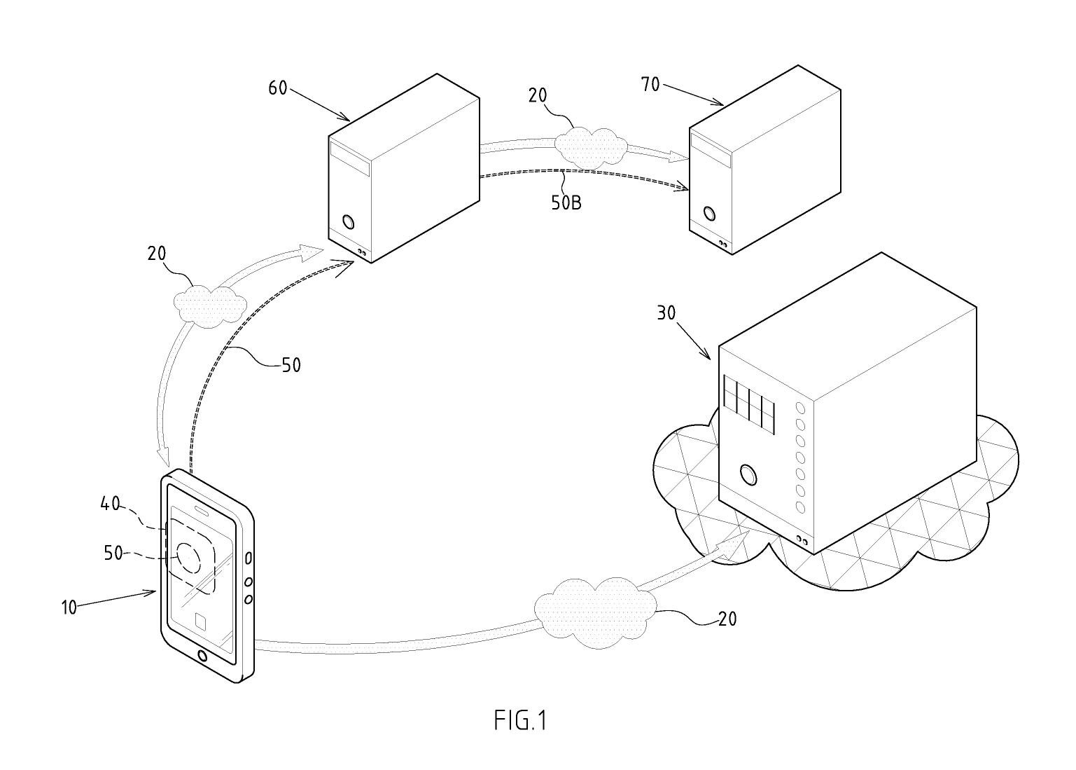

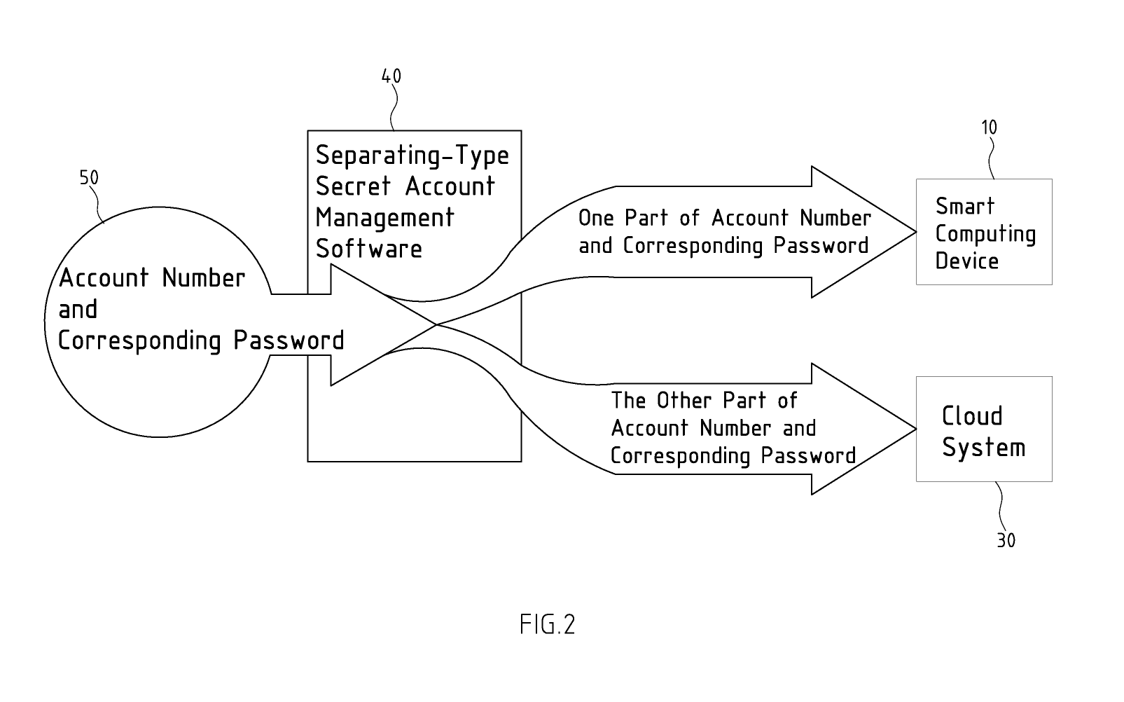

Referring to the drawings and initially to FIGS. 1 and 2, a digital apparatus being capable of separately saving an account number and corresponding password for anti-hacking purposes in accordance with the present invention comprises a smart computing device 10 that can be connected to at least one cloud system 30 via internet 20, wherein the smart computing device 10 can be a smart phone, a tablet, a desktop PC or a notebook. A separating-type secret account management software 40 is installed run and in the smart computing device 10 for encrypting account number and corresponding password 50. The separating-type secret account management software 40 respectively divides the account number and corresponding password 50 into two parts, wherein one part of the account number and corresponding password 50 is saved in the smart computing device 40 and the other part of the account number and corresponding password 50 is saved in the at least one cloud system 30. The separating-type secret account management software 40 collects the separated account number and corresponding password 50 from the smart computing device 10 and the at least one cloud system 30, and recovers the divided account number and corresponding password 50 to a complete and encrypted account number and corresponding password 50 when the operator want to use the account number and corresponding password 50. A decryption server 60 is connected to the smart computing device 10 for transceiving data and decrypting the complete and encrypted account number and corresponding password 50. An application server 70 is connected to the decryption server 60 for receiving the decrypted account number and corresponding password 50B from the decryption server 60.

The separating-type secret account management software 40 respectively collects the separated account number and corresponding password 50 from the smart computing device 10 and the at least one cloud system, and recovers the divided account number and corresponding password 50 to a complete and encrypted account number and corresponding password 50 when the operator want to use the account number and corresponding password 50. The complete and encrypted account number and corresponding password 50 is transmitted to the decryption server 60. Consequently, the digital apparatus in accordance with the present invention can prevent the account number and corresponding password 50 from being stolen during transmitting through the internet. In addition, the digital apparatus in accordance with the present invention can further prevent the account number and corresponding password 50 from being broken and stolen when being saved in a single system. Consequently, the account number and corresponding password 50 is anti-skimming and can be safely saved, and the application server 70 can be safely logged without changing the original design.

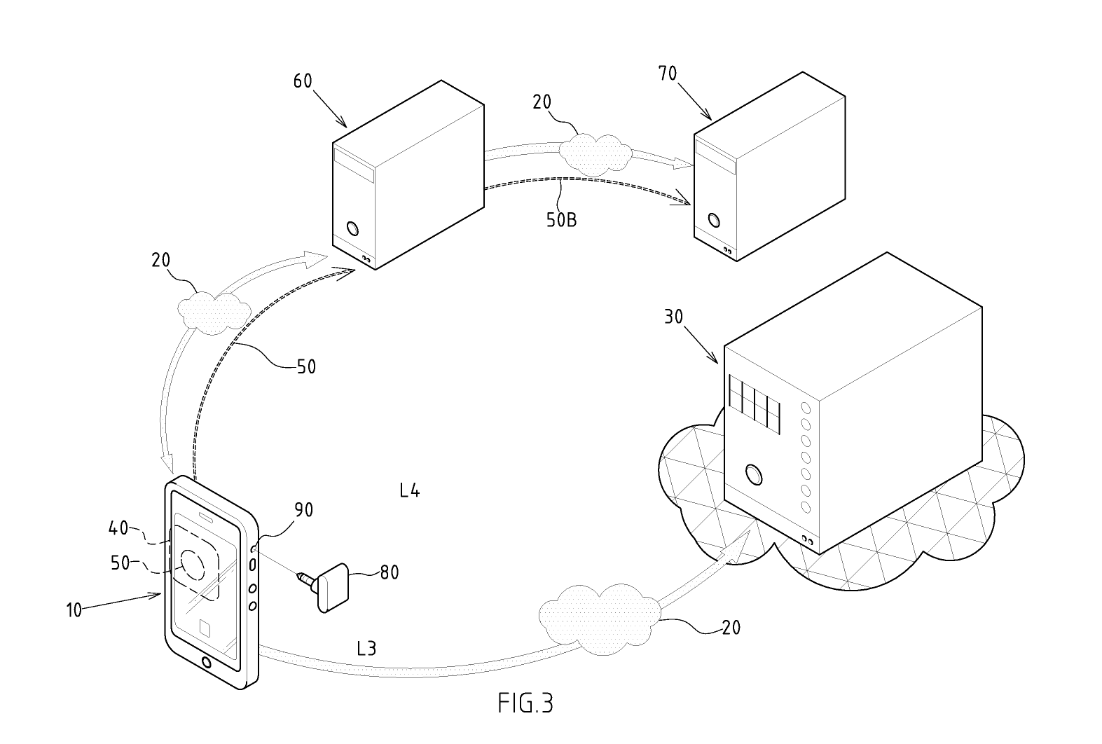

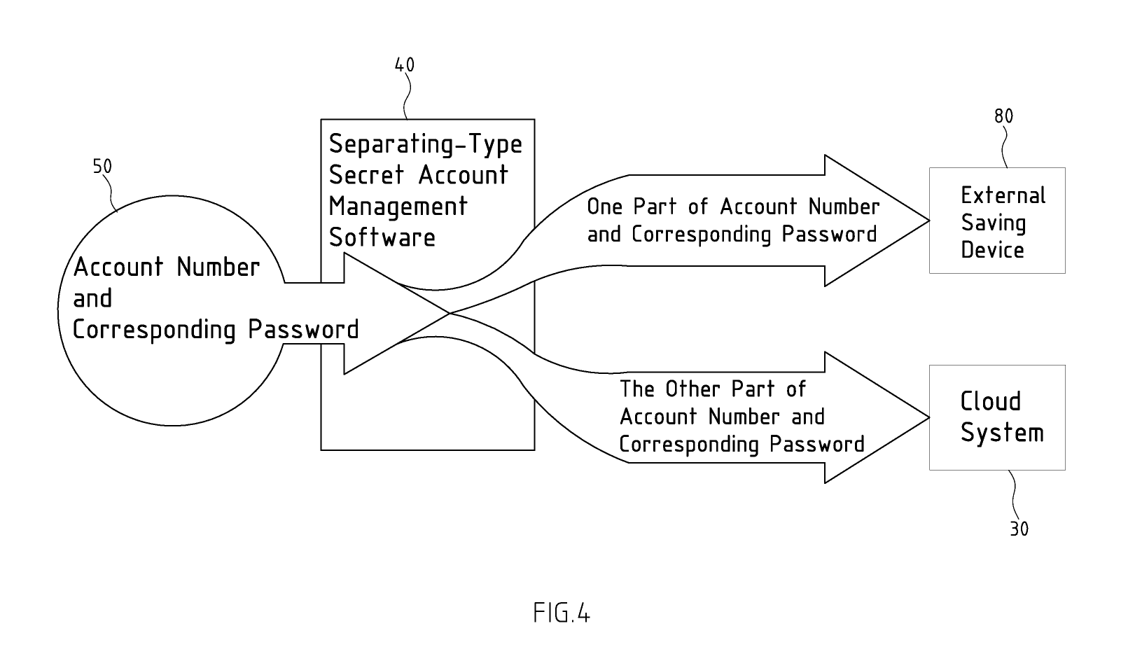

With reference to FIGS. 3 and 4, the digital apparatus in accordance with the present invention further includes an external saving device 80 connected to the smart computing device 10 via a transmitting interface 90 that is disposed in the smart computing device 10. In this embodiment, The separating-type secret account management software 40 divides the account number and corresponding password 50 into two parts, wherein one part of the account number and corresponding password 50 is saved in the external saving device 80 and the other part of the account number and corresponding password 50 is saved in the at least one cloud system 30. The separating-type secret account management software 40 collects the separated account number and corresponding password 50 from the external saving device 80 and the at least one cloud system 30, and recovers the divided account number and corresponding password 50 to a complete and encrypted account number and corresponding password 50 when the operator want to use the account number and corresponding password 50. A decryption server 60 is connected to the smart computing device 10 for transceiving data and decrypting the complete and encrypted account number and corresponding password 50. An application server 70 is connected to the decryption server 60 for receiving the decrypted account number and corresponding password 50B from the decryption server 60.

The transmitting interface 90 can be universal serial bus, Bluetooth, audio, lightning or Wi-Fi.

As described above, the account number and corresponding password 50 into two parts, wherein one part of the account number and corresponding password 50 is saved in the smart computing device 40 and the other part of the account number and corresponding password 50 is saved in the at least one cloud system 30. The separating-type secret account management software 40 collects the separated account number and corresponding password 50 from the smart computing device 10 and the at least one cloud system 30, and recovers the divided account number and corresponding password 50 to a complete and encrypted account number and corresponding password 50 when the operator want to use the account number and corresponding password 50. A decryption server 60 is connected to the smart computing device 10 for transceiving data and decrypting the complete and encrypted account number and corresponding password 50. An application server 70 is connected to the decryption server 60 for receiving the decrypted account number and corresponding password 50B from the decryption server 60. The separating-type secret account management software 40 collects the separated account number and corresponding password 50 from the smart computing device 10 and the at least one cloud system, and recovers the divided account number and corresponding password 50 to a complete and encrypted account number and corresponding password 50 when the operator want to use the account number and corresponding password 50. The complete and encrypted account number and corresponding password 50 is transmitted to the decryption server 60. Consequently, the digital apparatus in accordance with the present invention can prevent the account number and corresponding password 50 from being stolen during transmitting through the internet. In addition, the digital apparatus in accordance with the present invention can further prevent the account number and corresponding password 50 from being broken and stolen when being saved in a single system. Consequently, the account number and corresponding password 50 is anti-skimming and can be safely saved, and the application server 70 can be safely logged without changing the original design.

Although the invention has been explained in relation to its preferred embodiment, it is to be understood that many other possible modifications and variations can be made without departing from the spirit and scope of the invention as hereinafter claimed.

I claim:

1. A digital apparatus being capable of separately saving account number and password for anti-hack, comprising:
a smart computing device that can be connected to at least one cloud system via internet;
a separating-type secret account management software installed run and in the smart computing device for encrypting account number and corresponding password, the separating-type secret account management software respectively dividing the account number and corresponding password into two parts, wherein one part of the account number and corresponding password is saved in the smart computing device and the other part of the account number and corresponding password is saved in the at least one cloud system, the separating-type secret account management software collecting the separated account number and corresponding password from the smart computing device and the at least one cloud system, and recovering the divided account number and corresponding password to a complete and encrypted account number and corresponding password when the operator want to use the account number and corresponding password;
a decryption server connected to the smart computing device for transceiving data and decrypting the complete and encrypted account number and corresponding password; and an application server is connected to the decryption server for receiving the decrypted account number and corresponding password from the decryption server;
wherein:
the separating-type secret account management software respectively collects the separated account number and corresponding password from the smart computing device and the at least one cloud system, and recovers the divided account number and corresponding password to a complete and encrypted account number and corresponding password when the operator want to use the account number and corresponding password; and
the complete and encrypted account number and corresponding password is transmitted to the decryption server such that the digital apparatus in accordance with the present invention can prevent the account number and corresponding password from being stolen during transmitting through the internet and prevent the account number and corresponding password from being broken and stolen when being saved in a single system.

2. A digital apparatus being capable of separately saving account number and password for anti-hack, comprising:
a smart computing device that can be connected to at least one cloud system via internet;
an external saving device connected to the smart computing device via a transmitting interface that is disposed in the smart computing device;
a separating-type secret account management software installed run and in the smart computing device for encrypting account number and corresponding password, the separating-type secret account management software respectively dividing the account number and corresponding password into two parts, wherein one part of the account number and corresponding password is saved in the external saving device and the other part of the account number and corresponding password is saved in the at least one cloud system, the separating-type secret account management software collecting the separated account number and corresponding password from the external saving device and the at least one cloud system, and recovering the divided account number and corresponding password to a complete and encrypted account number and corresponding password when the operator want to use the account number and corresponding password;
a decryption server connected to the smart computing device for transceiving data and decrypting the complete and encrypted account number and corresponding password; and
an application server is connected to the decryption server for receiving the decrypted account number and corresponding password from the decryption server;
wherein:
the separating-type secret account management software respectively collects the separated account number and corresponding password from the external saving device and the at least one cloud system, and recovers the divided account number and corresponding password to a complete and encrypted account number and corresponding password when the operator want to use the account number and corresponding password; and
the complete and encrypted account number and corresponding password is transmitted to the decryption server such that the digital apparatus in accordance with the present invention can prevent the account number and corresponding password from being stolen during transmitting through the internet and prevent the account number and corresponding password from being broken and stolen when being saved in a single system.

3. The digital apparatus as claimed in claim 2, wherein the transmitting interface is selected from a group consisted of universal serial bus, Bluetooth, audio, lightning and Wi-Fi.
